(19) United States
(12) Patent Application Publication
(10) Pub. No.: US 2013/0080720 A1
(43) Pub. Date: Mar. 28, 2013

(54) INFORMATION PROCESSING APPARATUS AND METHOD

(71) Applicant: Minoru Nakamura, Kawasaki (JP)

(72) Inventor: Minoru Nakamura, Kawasaki (JP)

(73) Assignee: FUJITSU LIMITED, Kawasaki-shi (JP)

(21) Appl. No.: 13/569,289

(22) Filed: Aug. 8, 2012

(30) Foreign Application Priority Data
Sep. 27, 2011 (JP) 2011-211633

(51) Int. Cl. G06F 12/00

(52) U.S. Cl. 711/161; 711/E12.001

(57) ABSTRACT

A processor stores first information when first data is stored in a storage. The first information includes pointers pointing to primary blocks of the storage. Each of the primary blocks stores a divided part of the first data. The processor stores second information when data update for updating the first data to second data is performed. The second information includes pointers pointing to secondary blocks of the storage. Each of the secondary blocks stores a divided part of the second data. The second information does not include a first pointer included in the first information. The first pointer points to a first block storing a to-be-deleted portion. The second information includes a second pointer. The second pointer points to a second block storing an added portion. The second information includes a third pointer included in the first information. The third pointer points to a third block storing an unchanged portion.

### CROSS-REFERENCE TO RELATED APPLICATION

This application is based upon and claims the benefit of priority of the prior Japanese Patent Application No. 2011-211633, filed on Sep. 27, 2011, the entire contents of which are incorporated herein by reference.

### FIELD

The embodiment discussed herein is related to an information processing apparatus and an information processing method.

### BACKGROUND

There is a conventional technology of a log-structured file system.

In a log-structured file system, data in a file is updated by newly storing data after the update while leaving data before the update. Accordingly, it is possible to restore the file to a previous state. This enables the file to be restored to the immediately preceding state in case of failure in file update. It is also possible for a user of a file system to cancel the update and return the file to a previous state. In the log-structured file system described above, a conventional technology is available to speed up creation of a snapshot.

Another conventional technology is available to create a difference among a plurality of snapshots to manage their generations. A snapshot at a point of time is data by which the state of a file and directory at the point of time is identified.

Japanese Laid-open Patent Publication No. 2004-213647 and Japanese Laid-open Patent Publication No. 2010-026939 disclose related techniques.

### SUMMARY

According to an aspect of the present invention, provided is an information processing apparatus including a processor. The processor stores first pointer group information in a memory when first data is stored in a storage unit. The first pointer group information includes block pointers respectively pointing to primary data blocks of the storage unit. The primary data blocks store the first data. Each of the primary data blocks stores a divided part of the first data. The processor stores second pointer group information in the memory when data update for updating the first data to second data is performed. The second pointer group information includes block pointers respectively pointing to secondary data blocks of the storage unit. The secondary data blocks store the second data. Each of the secondary data blocks stores a divided part of the second data.

The second pointer group information does not include a first block pointer included in the first pointer group information when a to-be-deleted portion of the first data is deleted by the data update. The first block pointer points to a first data block storing the to-be-deleted portion. The second pointer group information includes a second block pointer when an added portion is added by the data update. The second block pointer points to a second data block storing the added portion. The second pointer group information includes a third block pointer included in the first pointer group information when an unchanged portion of the first data remains by the data update. The third block pointer points to a third data block storing the unchanged portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates how snapshots are created;

FIG. 2 is a block diagram illustrating an example of a hardware structure of an information processing apparatus in an embodiment;

FIG. 3 illustrates a first specific example of a data file;

FIG. 4 illustrates a second specific example of a data file;

FIG. 5 illustrates a third specific example of a data file;

FIG. 6 is a block diagram illustrating an example of a functional structure of an information processing apparatus;

FIG. 7 illustrates an example of a branchable snapshot;

FIG. 8 illustrates an example of a branchable snapshot g;

FIG. 9 illustrates an example of a branchable snapshot;

FIG. 10 illustrates an example of a branchable snapshot g;

FIG. 11 illustrates a specific example of block pointers P used during creation of a snapshot;

FIG. 12 illustrates a specific example of block pointers P used during creation of a snapshot;

FIG. 13 illustrates a specific example of block pointers P used during creation of a snapshot;

FIG. 14 illustrates a specific example of garbage collection by an information processing apparatus.

FIG. 15 illustrates an example of a user interface of snapshots;

FIG. 16 is a flowchart illustrating a process of data reading;

FIG. 17 is a flowchart illustrating a process of entry retrieval;

FIG. 18 is a flowchart illustrating a process of data block retrieval;

FIG. 19 is a flowchart illustrating a process of block map search; and

FIGS. 20A and 20B illustrate a flowchart of a process of data writing.

### DESCRIPTION OF EMBODIMENT

Conventionally created snapshots are time-series snapshots (so-called “read-only snapshots”). Accordingly, all that is possible for previous files and directories is to retrieve them. It is difficult to selectively use the files or directories in a restored state and in a state before restoration.

An embodiment of an information processing apparatus and an information processing method will be described in detail with reference to the drawings. The information processing apparatus uses a log-structured file system as a method of handling a resource (storage area). In the log-structured file system, the information processing apparatus divides the storage area into data blocks and uses one or a plurality of data blocks to store data (such as, for example, a file or directory). When a file stored in the information processing apparatus is to be changed, the information processing apparatus leaves a data block (referred to below as a “to-be-reflected data block”), in the file, the data stored in which is to be changed. In addition to the to-be-reflected data block, the information processing apparatus newly stores a reflected data block created by reflecting the change in the to-be-reflected data block.

The information processing apparatus, which uses the log-structured file system, is configured so that a plurality of snapshots may be created and may be present concurrently. The information processing apparatus is also configured so that a plurality of snapshots may be created from one snapshot by making the snapshot branch. To achieve this, the information processing apparatus saves a pointer group that points to a data block group included in a file as a snapshot corresponding to the file.

When the file is to be changed, the information processing apparatus leaves the snapshot corresponding to the file before the change and stores a new snapshot corresponding to a file after the change. In the new snapshot, compared to the snapshot before the change, a block pointer pointing to the to-be-reflected data block has been replaced with a block pointer pointing to a new data block in which the change has been reflected. Thus, the information processing apparatus enables a plurality of snapshots to be present concurrently.

The information processing apparatus also performs garbage collection to delete unnecessary data blocks to release a resource. In this garbage collection, the information processing apparatus deletes data blocks that are not pointed by any of the saved snapshots. Then, the information processing apparatus may create a snapshot that may branch in the log-structured file system.

### Creation of Snapshots

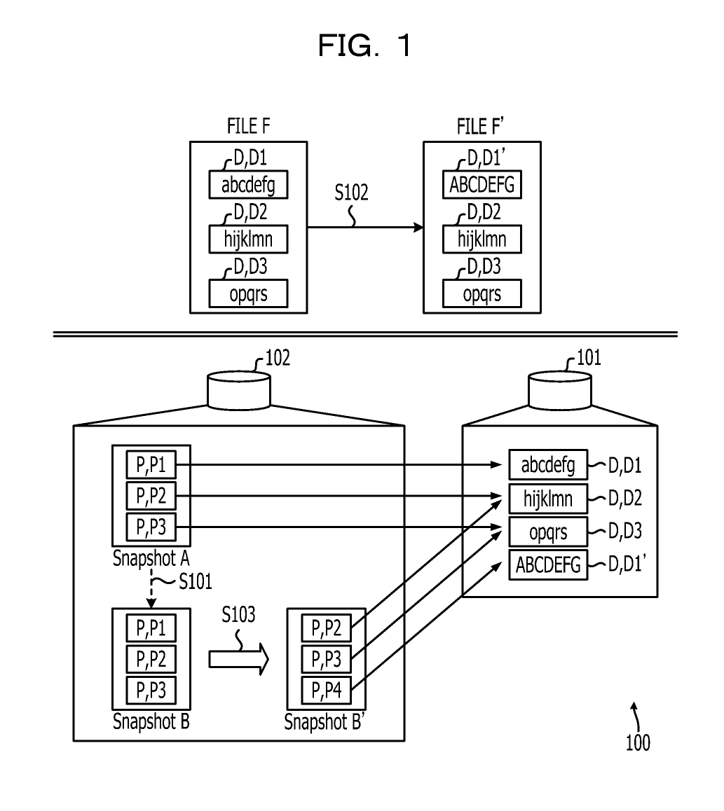

First, creation of snapshots will be described with reference to FIG. 1.

FIG. 1 illustrates how snapshots are created. Data blocks D1 to D3 included in a file F have been allocated in a storage area 101 in the information processing apparatus 100. A snapshot A in which a block pointer P group pointing to a data block D group included in the file F is saved is stored in a storage area 102 in the information processing apparatus 100. The snapshot A includes block pointer P1 pointing to data block D1, block pointer P2 pointing to data block D2, and block pointer P3 pointing to data block D3.

The file F, which is a combination of data blocks D1 to D3, is displayed on the user interface of the information processing apparatus 100. The user of the information processing apparatus 100 performs deletion, addition, or modification on data in the file F.

First, in S101 in FIG. 1, the information processing apparatus 100 copies the snapshot A to create a snapshot B for the file F. The snapshot B includes block pointer P1 pointing to data block D1, block pointer P2 pointing to data block D2, and block pointer P3 pointing to data block D3.

In S102, the contents of the file F are then changed from the state corresponding to the snapshot B. When data block D1 is to be changed, in addition to the data block D1 before the change, the information processing apparatus 100 stores data block D1′ after the change.

In S103, the information processing apparatus 100 then deletes, from the copied snapshot B, block pointer P1 pointing to data block D1 before the change. The information processing apparatus 100 also newly adds, to the copied snapshot B, block pointer P4 pointing to data block D1′ after the change.

As a result, a snapshot B′ including a block pointer P group pointing to a data block D group included in the file F′ after the change is created, indicating that both the snapshot A and the snapshot B′ are present concurrently. Accordingly, the user may use the file F before the change by combining the data blocks D pointed to by the block pointers P in the snapshot A. The user may also use the file F′ after the change by combining the data blocks D pointed to by the block pointers P in the snapshot B′.

As described above, since both the snapshots before the change and the snapshot after the change are present concurrently, the user may selectively use the file before the change and the file after the change. The user may also create a snapshot, differing from the snapshot B′, from the snapshot A while leaving the snapshot A and snapshot B′.

### Hardware Structure of the Information Processing Apparatus 100

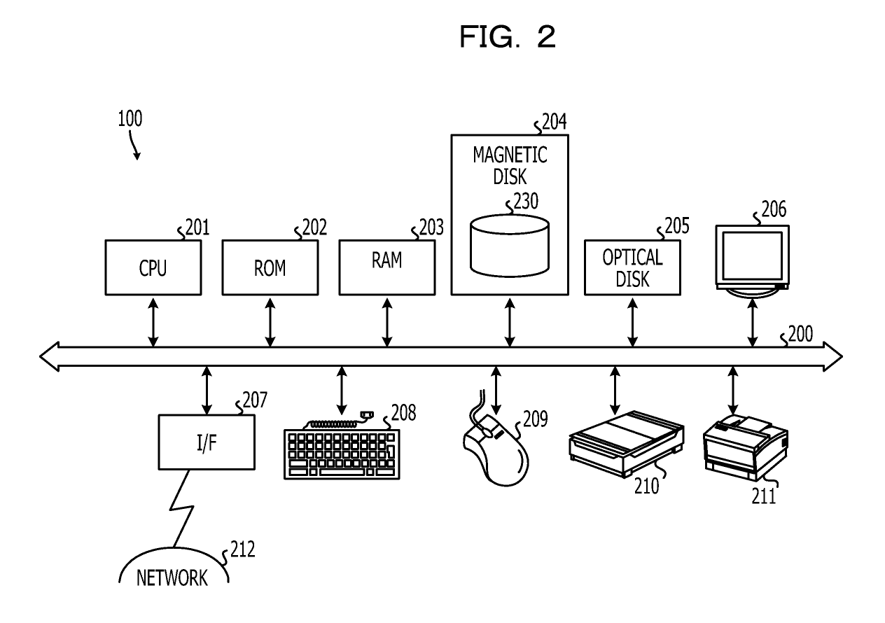

FIG. 2 is a block diagram illustrating an example of a hardware structure of the information processing apparatus 100 in the embodiment. The information processing apparatus 100 in FIG. 2 includes a central processing unit (CPU) 201, a read-only memory (ROM) 202, a random access memory (RAM) 203, a magnetic disk 204, an optical disk 205, a display unit 206, an interface (I/F) 207, a keyboard 208, a mouse 209, a scanner 210, and a printer 211. These components are mutually connected through a bus 200.

The CPU 201 controls the entire information processing apparatus 100. The ROM 202 stores a boot program and other programs. The RAM 203 is used as a work area of the CPU 201.

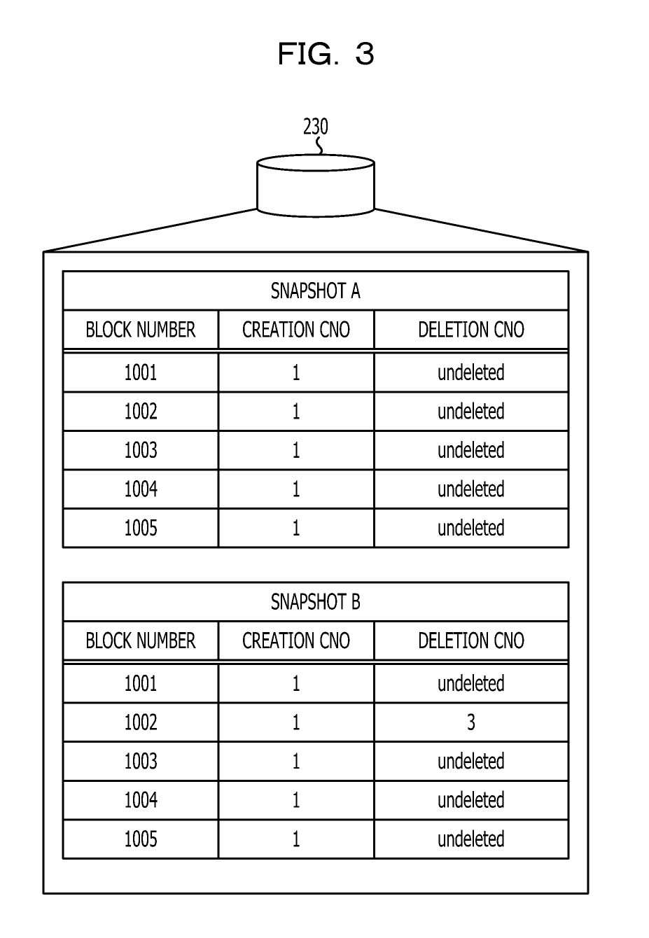

The magnetic disk 204 is a recording medium from which data is read and to which data is written under control of the CPU 201. The magnetic disk 204 stores data written to it under control of the CPU 201. For example, a log-structured file system is created on the magnetic disk 204 and data blocks D are allocated in it. The magnetic disk 204 also stores a data file 230 that is referenced by the information processing apparatus 100 when the information processing apparatus 100 executes garbage collection. The contents stored in the data file 230 will be described below with reference to FIGS. 3 to 5.

The optical disk 205 is a recording medium from which data is read and to which data is written under control of the CPU 201. The optical disk 205 stores data written to it under control of the CPU 201, and allows a computer to read the data stored on the optical disk 205.

The display unit 206 displays a cursor, icons, a tool box, and data such as texts, images, and function information. Examples of the display unit 206 include a cathode-ray tube (CRT) display unit, a thin-film transistor (TFT) display unit, and a plasma display unit.

The interface 207 is connected to a network 212, which is, for example, a local area network (LAN), a wide area network (WAN), or the Internet. The information processing apparatus 100 is connected to other apparatuses through the network 212. The interface 207 functions as an interface between the network 212 and the inside of the information processing apparatus 100, and controls reception of data from and output of data to the external apparatuses. Examples of the interface 207 include a modem and a LAN adapter.

The keyboard 208, which has keys used to input characters, numbers, commands, and the like, is used to input data. The keyboard 208 may be a touch-panel input pad or a numeric keypad. The mouse 209 is used to, for example, move the cursor, select a range, move a window, and change the size of a window. The mouse 209 may be a trackball, a joystick or something that has similar functions as a pointing device.

The scanner 210 optically reads an image and stores image data in the information processing apparatus 100. The scanner 210 may have a function of an optical character reader (OCR). The printer 211 prints image data and text data. Examples of the printer 211 include a laser printer and an ink jet printer.

The information processing apparatus 100 may create the log-structured file system in an external storage unit connected through a storage adapter.

### First Specific Example of the Data File 230

A first example of the data file 230 stored on the magnetic disk 204 will be described with reference to FIG. 3.

FIG. 3 illustrates the first specific example of the data file 230. As illustrated in FIG. 3, the data file 230 is created for each of snapshots. A record in the data file 230 has a creation checkpoint number (CNO) field and a deletion CNO field in correspondence to a block number field. In the data file 230, a record is set each time a data block D is created, and the record is updated each time the relevant data block D is deleted.

The block number field stores an identifier identifying a data block D, which is assigned in the order in which data blocks D are created. The creation CNO field stores a CNO at the time when a data block D was created. The deletion CNO field stores a CNO at the time when the relevant data block D was deleted. The CNO is a counter that is incremented when a data block D is changed, created, or deleted.

### Second Specific Example of the Data File 230

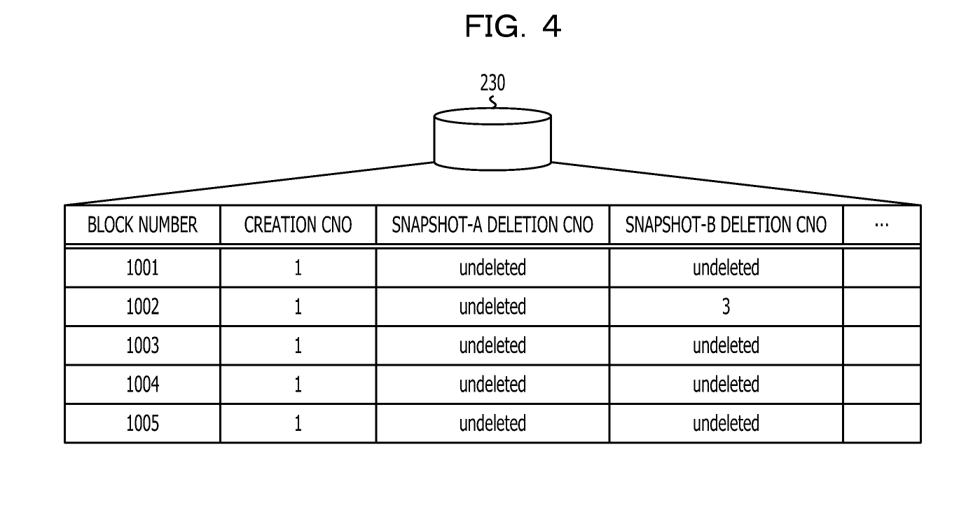

A second example of the data file 230 stored on the magnetic disk 204 will be described with reference to FIG. 4.

FIG. 4 illustrates the second specific example of the data file 230. As illustrated in FIG. 4, a record in the data file 230 has a creation CNO field and snapshot-specific deletion CNO fields (snapshot-A deletion CNO field and snapshot-B deletion CNO field in this example) in correspondence to a block number field. In the data file 230, a record is set each time a data block D is created, and the record is updated each time the relevant data block D is deleted. The number of the snapshot-specific deletion CNO fields is increased each time a snapshot is created.

The block number field stores an identifier identifying a data block D, which is assigned in the order in which data blocks D are created. The creation CNO field stores a CNO at the time when a data block D was created.

The snapshot-A deletion CNO field stores a CNO at the time when the relevant data block D was deleted in the snapshot A. The snapshot-B deletion CNO field stores a CNO at the time when the relevant data block D was deleted in the snapshot B.

### Third Specific Example of the Data File 230

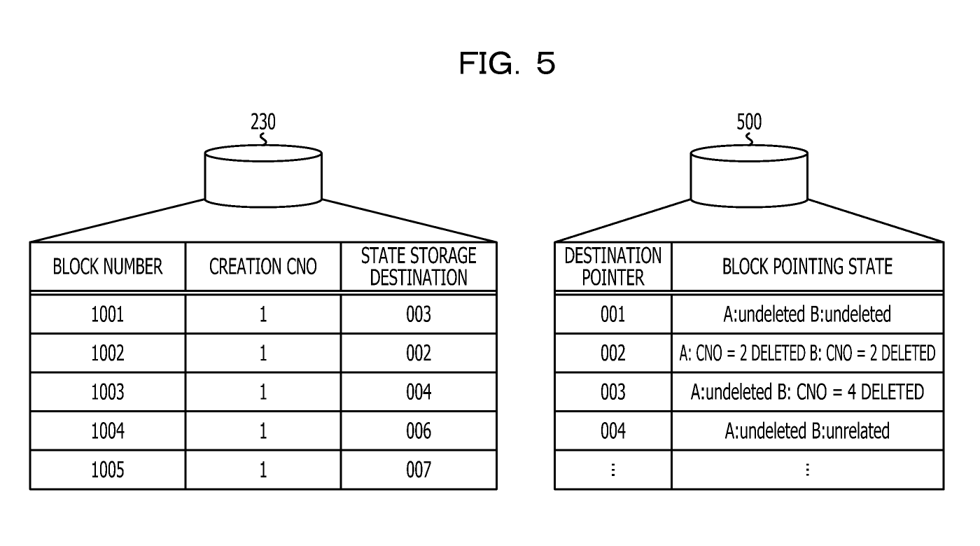

A third example of the data file 230 stored on the magnetic disk 204 will be described with reference to FIG. 5. As illustrated in FIG. 5, the magnetic disk 204 stores the data file 230 and an auxiliary table 500, which assists the data file 230.

FIG. 5 illustrates the third specific example of the data file 230. A record in the data file 230 has a creation CNO field and a state storage destination field in correspondence to a block number field. In the data file 230, a record is set each time a data block D is created, and the record is updated each time the relevant data block D is deleted.

The block number field stores an identifier identifying a data block D, which is assigned in the order in which data blocks D are created. The creation CNO field stores a CNO at the time when a data block D was created. The state storage destination field stores a destination pointer of a record in the auxiliary table 500, which stores information about whether the relevant data block D is pointed to by each snapshot.

As illustrated in FIG. 5, a record in the auxiliary table 500 has a block pointing state field in correspondence to a destination pointer field. In the auxiliary table 500, a record is set each time a data block D is created, and the record is updated each time the relevant data block D is deleted.

The destination pointer field stores an identifier assigned each time a data block D is created or deleted. The block pointing state field stores information about whether the relevant data block D is pointed to by each snapshot when a data block D is created or deleted.

Thus, the use of the auxiliary table 500 enables the number of columns of the data file 230 and the auxiliary table 500 to be fixed. The data file 230 and auxiliary table 500 may thereby be created or update easier than the data file 230 illustrated in FIGS. 3 and 4 is created or updated. Since the data file 230 is not copied during the copying of a snapshot, the amount of processing by the information processing apparatus 100 is reduced.

### Functional Structure of the Information Processing Apparatus 100

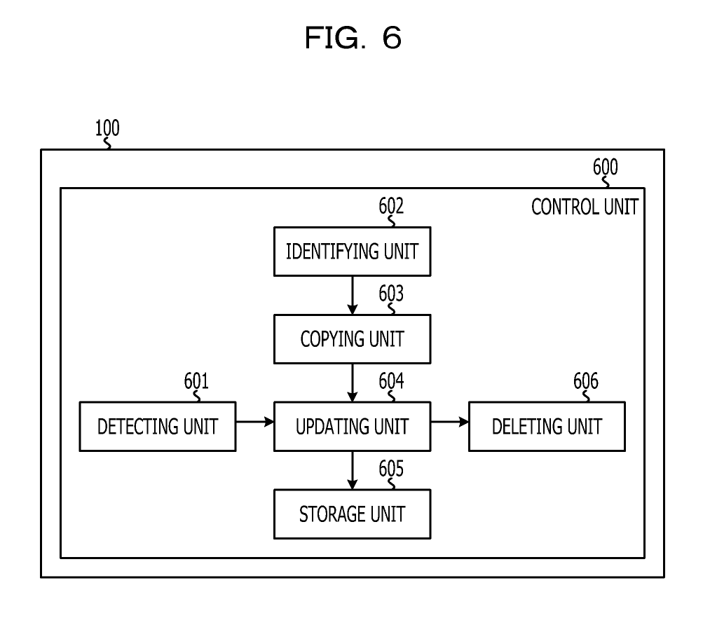

Next, an example of a functional structure of the information processing apparatus 100 will be descried with reference to FIG. 6.

FIG. 6 is a block diagram illustrating an example of a functional structure of the information processing apparatus 100. The information processing apparatus 100 includes a control unit 600. The control unit 600 includes a detecting unit 601, an identifying unit 602, a copying unit 603, an updating unit 604, a storage unit 605, and a deleting unit 606. The detecting unit 601, identifying unit 602, copying unit 603, updating unit 604, storage unit 605, deleting unit 606 constitute a control unit 600. Specifically, the functions of the control unit 600 are implemented by, for example, causing the CPU 201 to execute programs stored on recording media such as the ROM 202, RAM 203, magnetic disk 204, and optical disk 205 illustrated in FIG. 2. A part of these functions may be implemented through the interface 207.

The control unit 600 performs storage control as follows. When data that is divided into parts and stored in a plurality of data blocks D is updated, both first pointer group information and second pointer group information are stored in a storage unit. The first pointer group information includes a plurality of pointers P, each of which points to one of the plurality of data blocks D before the update. The second pointer group information includes a plurality of pointers P, each of which points to one of a plurality of data blocks D in which data after the update has been divided into parts and stored. The data is, for example, a file that the user has updated. The pointer group information is a group of block pointers P that point to data blocks D included in one file, in other words, the pointer group information is the snapshot described above.

When data is deleted by the update, the second pointer group information is a snapshot that excludes a block pointer P pointing to a data block D in which the deleted data had been stored. When data is added by the update, the second pointer group information is a snapshot that includes a block pointer P pointing to a data block D in which the added data has been newly stored. When there is data that remains unchanged by the update, the second pointer group information is a snapshot that includes a block pointer P pointing to a data block D in which the unchanged data had been stored. In the description below, a data block D in which the data to be deleted is stored will be referred as a “to-be-deleted data block”, a data block D in which the added data is stored will be referred to as a “to-be-added data block”, and a data block D that is changed by the update will be referred to as a “to-be-reflected data block”.

When there is data to be deleted by the update, The control unit 600 updates, in a first database, a destination pointer for a data block in which the data to be deleted is stored to a new destination pointer corresponding to a new block pointing state in which the data block is pointed to by the first pointer group information and is not pointed to by the second pointer group information. The control unit 600 adds to a second database a new record storing information indicating the new block pointing state in correspondence to the new destination pointer. When there is data to be added by the update, the control unit 600 adds to the first database a new record storing a new destination pointer for a new data block, in which the added data is stored, in correspondence to information indicating the new data block. The control unit 600 adds to a second database a new record storing information indicating a new block pointing state in correspondence to the new destination pointer. In the new block pointing state, the data block is not pointed to by the first pointer group information and is pointed to by the second pointer group information.

When there is data to be deleted by the update, the control unit 600 may update, in the first database, a destination pointer for a data block in which the data to be deleted is stored to a specific destination pointer. The specific destination pointer has been stored in the second database in correspondence to information indicating a block pointing state in which the data block is pointed to by the first pointer group information and is not pointed to by the second pointer group information. When there is data to be added by the update, the control unit 600 may add to the first database a new record storing a specific destination pointer in correspondence to information indicating the data block in which the added data is stored. The specific destination pointer has been stored in the second database in correspondence to information indicating a block pointing state in which the data block is not pointed to by the first pointer group information and is pointed to by the second pointer group information.

The control unit 600 may delete a data block in a data block group, which is not pointed to by any pointing information in any pointer group information with reference to the first database and the second database.

The detecting unit 601, the identifying unit 602, the copying unit 603, the updating unit 604, the storage unit 605, the deleting unit 606, which work as functions of the control unit 600, will be specifically described below. The detecting unit 601 detects a to-be-reflected data block from a set of data blocks, which is a set of data blocks D stored by the information processing apparatus 100 in the RAM 203, the magnetic disk 204, the optical disk 205, and other storage areas. A to-be-reflected data block is a data block D corresponding to a portion changed by the user in a file, that is, a data block D in which the change is to be reflected. Specifically, for example, the detecting unit 601 detects, from a set of data blocks D, a data block D corresponding to a portion changed by the user in a file. Thus, the detecting unit 601 may detect the to-be-reflected data block.

The detecting unit 601 detects a to-be-deleted data block from a set of data blocks. The to-be-deleted data block is a data block D corresponding to a portion which is deleted by the user from a file. Specifically, for example, the detecting unit 601 detects, from a set of data blocks D, a data block D corresponding to a portion, in a file, deleted by the user. Thus, the detecting unit 601 may detect the to-be-deleted data block D.

The detecting unit 601 detects a to-be-added data block from a set of data blocks. The to-be-added data block is a data block D corresponding to a portion which is added by the user to a file. Specifically, for example, the detecting unit 601 detects, from a set of data blocks D, a data block D corresponding to a portion which is added by the user to a file. The detected data block D is stored in the RAM 203, the magnetic disk 204, the optical disk 205, and other storage areas. Thus, the detecting unit 601 may detect the fact that a to-be-added data block is not included in the data block group D.

The identifying unit 602 identifies a first pointing information group that points to a data block group including a to-be-reflected data block from a set of pointing information groups, each of which points to a data block group in a set of data blocks. A data block group in a set of data blocks is a data block D group included in one file among a set of data blocks D stored in the information processing apparatus 100. A pointing information group, which points to a data block group, is information about block pointer P group pointing to a data block D group included in one file, that is, the pointer group information described above or the snapshot described above. Specifically, for example, the identifying unit 602 identifies a block pointer P group that points to a data block D group included in a file that includes a portion which is changed by the user. The data block group D includes a data block D corresponding to the changed portion. Thus, the identifying unit 602 may identify a snapshot corresponding to a file including a portion changed by the user.

The identifying unit 602 identifies a first pointing information group that points to a data block group including a to-be-deleted data block from a set of pointing information groups, each of which points to a data block group in a set of data blocks. Specifically, for example, the identifying unit 602 identifies a block pointer P group that points to a data block D group included in a file that includes a portion which is deleted by the user. The data block group D includes a data block D corresponding to the deleted portion. Thus, the identifying unit 602 may identify a snapshot corresponding to a file including a portion deleted by the user.

The identifying unit 602 identifies a first pointing information group that points to a to-be-added data block group from a set of pointing information groups, each of which points to a data block group in a set of data blocks. Specifically, for example, the identifying unit 602 identifies a block pointer P group that points to a data block D group included in a file that has a portion added by the user and does not include a data block D corresponding to the added portion. The identification result is stored in the RAM 203, the magnetic disk 204, the optical disk 205, and other storage areas. Thus, the identifying unit 602 may identify a snapshot corresponding to a file that has a portion added by the user.

The copying unit 603 copies the first pointing information group identified by the identifying unit 602. Specifically, for example, the copying unit 603 copies a block pointer P group identified by the identifying unit 602 to obtain a second pointer group. Thus, the copying unit 603 may leave a snapshot corresponding to a file in which the change is yet to be reflected.

The copying unit 603 copies the first pointing information group identified by the identifying unit 602. Specifically, for example, the copying unit 603 copies a block pointer P group identified by the identifying unit 602 to obtain a second pointer group. Thus, the copying unit 603 may leave a snapshot corresponding to a file, a portion of which is yet to be deleted.

The copying unit 603 copies the first pointing information group identified by the identifying unit 602. Specifically, for example, the copying unit 603 copies a block pointer P group identified by the identifying unit 602 to obtain a second pointer group. Thus, the copying unit 603 may leave a snapshot corresponding to a file, to which data is yet to be added. The copying result is stored in the RAM 203, the magnetic disk 204, the optical disk 205, and other storage areas.

When a to-be-reflected data block is detected by the detecting unit 601, the updating unit 604 deletes pointing information that points to the to-be-reflected data block from the second pointing information group copied from the first pointing information group by the copying unit 603. The updating unit 604 adds, to the second pointing information group, pointing information that points to a reflected data block D created by the reflection in the to-be-reflected data block. Specifically, for example, when a data block D corresponding to a to-be-changed portion is detected by the detecting unit 601, the updating unit 604 deletes a block pointer P that points to the data block D corresponding to the to-be-changed portion from the block pointer P group copied by the copying unit 603. The updating unit 604 adds, to the block pointer P group copied by the copying unit 603, a block pointer P that points to a reflected data block D created by reflecting the change in the data block D corresponding to the to-be-changed portion. Thus, the updating unit 604 may create a snapshot corresponding to a file after the change.

When a to-be-deleted data block is detected by the detecting unit 601, the updating unit 604 deletes pointing information that points to the to-be-deleted data block from the second pointing information group copied from the first pointing information group by the copying unit 603. Specifically, for example, when a data block D corresponding to a to-be-deleted portion is detected by the detecting unit 601, the updating unit 604 deletes a block pointer P that points to the data block D corresponding to the to-be-deleted portion from the block pointer P group copied by the copying unit 603. Thus, the updating unit 604 may create a snapshot corresponding to a file after the deletion.

When a to-be-added data block is detected by the detecting unit 601, the updating unit 604 adds pointing information that points to the to-be-added data block to the second pointing information group copied from the first pointing information group by the copying unit 603. Specifically, for example, when a data block D corresponding to a to-be-added portion is not detected by the detecting unit 601, the updating unit 604 adds a block pointer P that points to a data block D corresponding to the to-be-added portion to the block pointer P group copied by the copying unit 603. Thus, the updating unit 604 may create a snapshot corresponding to a file after the addition.

When the reflection is performed, the updating unit 604 adds, to the first database, a record storing a destination pointer for the reflected data block D in correspondence to information indicating the reflected data block D. The updating unit 604 also adds, to the second database, a record storing information indicating a block pointing state in which the reflected data block D is not pointed to by the first pointing information group and is pointed to by the second pointing information group in correspondence to the destination pointer for the reflected data block D. The updating unit 604 also updates the destination pointer for the to-be-reflected data block in the first database to a new destination pointer. The updating unit 604 also adds, to the second database, a record storing information indicating a block pointing state in which the to-be-reflected data block is pointed to by the first pointing information group and is not pointed to by the second pointing information group in correspondence to the new destination pointer for the to-be-reflected data block.

Specifically, for example, when the reflection is performed, the updating unit 604 adds, to the data file 230, a record storing a new destination pointer in correspondence to information indicating the reflected data block D. The updating unit 604 also adds, to the auxiliary table 500, a record storing information indicating a block pointing state in which the reflected data block D is pointed to or not by each snapshot, in correspondence to the new destination pointer. The updating unit 604 also updates the destination pointer stored in the data file 230 in correspondence to the data block D corresponding to the to-be-reflected portion to a new destination pointer. The updating unit 604 also adds, to the auxiliary table 500, a record storing information indicating a block pointing state in which the data block D corresponding to the to-be-reflected portion is pointed to or not by each snapshot in correspondence to the new destination pointer. Thus, the updating unit 604 may update the data file 230 and auxiliary table 500.

When the reflection is performed, the updating unit 604 adds, to the first database, a record storing the destination pointer stored in the second database in correspondence to information indicating the block pointing state in which the reflected data block D in not pointed to by the first pointing information group and is pointed to by the second pointing information group in correspondence to information indicating the reflected data block D. The updating unit 604 may also update, in the first database, the destination pointer for the to-be-reflected data block to the destination pointer stored in the second database in correspondence to information indicating the block pointing state in which the to-be-reflected data block is pointed to by the first pointing information group and is not pointed to by the second pointing information group.

Specifically, for example, when the reflection is performed, the updating unit 604 adds, to the data file 230, a record storing information indicating the reflected data block D in correspondence to the destination pointer stored in the auxiliary table 500 in correspondence to information indicating a block pointing state in which the reflected data block D is pointed to or not by each snapshot. When the reflection is performed, the updating unit 604 may also update the destination pointer stored in the data file 230 in correspondence to information indicating the data block D corresponding to the to-be-reflected portion to the destination pointer stored in the auxiliary table 500 in correspondence to information indicating a block pointing state in which the data block D corresponding to the to-be-reflected portion is pointed to or not by each snapshot. Thus, the updating unit 604 may update the data file 230.

When pointing information pointing to a to-be-deleted data block is deleted, the updating unit 604 updates, in the first database, the destination pointer for the to-be-deleted data block to a new destination pointer. The updating unit 604 also adds, to the second database, a record storing information indicating the block pointing state in which the to-be-deleted data block is pointed to by the first pointing information group and is not pointed to by the second pointing information group in correspondence to the new destination pointer for the to-be-deleted data block. Thus, the updating unit 604 may update the data file 230 and auxiliary table 500.

Specifically, for example, when a block pointer P pointing to a data block D corresponding to a to-be-deleted portion is deleted, the updating unit 604 updates the destination pointer stored in the data file 230 in correspondence to the data block D corresponding to the to-be-deleted portion to a new destination pointer. The updating unit 604 also adds, to the auxiliary table 500, a record storing information indicating a block pointing state in which the data block D corresponding to the to-be-deleted portion is pointed or not by each snapshot in correspondence to the new destination pointer. Thus, the updating unit 604 may update the data file 230 and auxiliary table 500.

When pointing information pointing to a to-be-deleted data block is deleted, the updating unit 604 may update, in the first database, the destination pointer for the to-be-deleted data block to the destination pointer stored in the second database in correspondence to information indicating a block pointing state in which the to-be-deleted data block is pointed to by the first pointing information group and is not pointed to by the second pointing information group.

Specifically, for example, when a block pointer P pointing to the data block D corresponding to a to-be-deleted portion is deleted, the updating unit 604 may update the destination pointer stored in the data file 230 in correspondence to information indicating a data block D corresponding to the to-be-deleted portion to the destination pointer stored in the auxiliary table 500 in correspondence to information indicating a block pointing state in which the data block D corresponding to the to-be-deleted portion is pointed to or not by each snapshot. Thus, the updating unit 604 may update the data file 230.

When a to-be-added data block is added, the updating unit 604 adds, to the first database, a record storing a destination pointer for the to-be-added data block in correspondence to information indicating the to-be-added data block. The updating unit 604 also adds, to the second database, a record storing information indicating a block pointing state in which the to-be-added data block is not pointed to by the first pointer group information and is pointed to by the second pointer group information in correspondence to the destination pointer for the to-be-added data block.

Specifically, for example, when a data block D corresponding to a to-be-added portion is added, the updating unit 604 adds, to the data file 230, a record storing a new destination pointer in correspondence to information indicating the data block D corresponding to the to-be-added portion. The updating unit 604 also adds, to the auxiliary table 500, a record storing information indicating a block pointing state in which the data block D corresponding to the to-be-added portion is pointed to or not by each snapshot in correspondence to the new destination pointer. Thus, the updating unit 604 may update the data file 230 and auxiliary table 500.

When a to-be-added data block is added, The updating unit 604 may add, to the first database, a record storing a destination pointer stored in the second database in correspondence to information indicating a block pointing state in which the to-be-added data block is not pointed to by the first pointing information group and is pointed to by the second pointing information group.

Specifically, for example, when a data block D corresponding to a to-be-added portion is added, the updating unit 604 may add, to the data file 230, a record storing a destination pointer in correspondence to information indicating a data block D corresponding to the to-be-added portion. The destination pointer is stored in the auxiliary table 500 in correspondence to information indicating a block pointing state in which the data block D corresponding to the to-be-added portion is pointed to or not by each snapshot. Thus, the updating unit 604 may update the data file 230.

The storage unit 605 stores the reflected data block D in a set of data blocks and also stores the second pointing information group updated by the updating unit 604 in a set of pointing information groups. Specifically, for example, in addition to the data block D corresponding to the to-be-changed portion, the storage unit 605 stores the reflected data block D created by reflecting the change in the data block D corresponding to the to-be-changed portion in a set of data blocks D. The storage unit 605 also stores a block pointer P group updated by the updating unit 604 in a set of block pointer P groups. Thus, the storage unit 605 may store the data block D after the change while leaving the data block D before the change. The storage unit 605 may also store a newly created snapshot.

The storage unit 605 stores the second pointing information group updated by the updating unit 604 in a set of pointing information groups. Specifically, for example, the storage unit 605 stores a block pointer P group updated by the updating unit 604 in a set of block pointer P groups. Thus, the storage unit 605 may store a newly created snapshot.

The storage unit 605 stores a to-be-added data block in a set of data blocks and also stores the second pointing information group updated by the updating unit 604 in a set of pointing information groups. Specifically, for example, the storage unit 605 stores a data block D corresponding to the to-be-added portion in a set of data blocks D. The storage unit 605 also stores a block pointer P group updated by the updating unit 604 in a set of block pointer P groups. Thus, the storage unit 605 may store the added data block D. The storage unit 605 may also store a newly created snapshot.

The deleting unit 606 references the first database and second database and deletes, from a set of data blocks, a data block that is not pointed to by any pointing information in a set of pointing information groups. Specifically, for example, the deleting unit 606 references the data file 230 and auxiliary table 500 and deletes a data block D that is not pointed to in any snapshot. Thus, the deleting unit 606 may execute garbage collection.

### Example of Branchable Snapshot

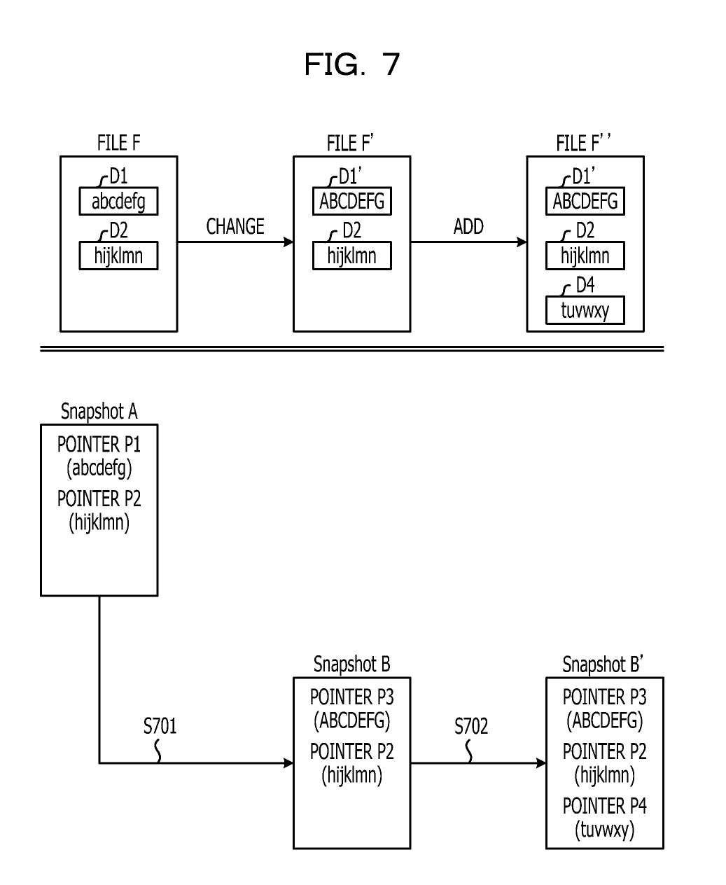

Next, an example of a branchable snapshot will be described with reference to FIGS. 7 to 10.

FIGS. 7 to 10 illustrate an example of a branchable snapshot. In FIG. 7, a snapshot A has been created for a file F including a data block D1 and a data block D2. The snapshot A includes a block pointer P1 pointing to the data block D1 and a block pointer P2 pointing to the data block D2.

In S701 in FIG. 7, the user of the information processing apparatus 100 first copies the snapshot A to obtain a snapshot B. The user of the information processing apparatus 100 then uses the information processing apparatus 100 to change data block D1 in the file F corresponding to the snapshot A. The information processing apparatus 100 updates the snapshot B to a snapshot B for a file F′ after the change while leaving the snapshot A for the file F before the change. Specifically, the information processing apparatus 100 deletes from the snapshot B the block pointer P1 pointing to the data block D1 before the change, and add to the snapshot B a block pointer P3 pointing to a data block D1′ after the change. Then, the file F′ corresponding to the snapshot B is displayed on the user interface of the information processing apparatus 100.

In S702, the user of the information processing apparatus 100 copies the snapshot B to obtain a snapshot B′. The user of the information processing apparatus 100 then uses the information processing apparatus 100 to add a data block D4 to the file F′ corresponding to the snapshot B to obtain a file F″. The information processing apparatus 100 updates the snapshot B′ to a snapshot B′ for a file F″ after the addition while leaving the snapshot B for the file F′ before the addition. Specifically, the information processing apparatus 100 adds to the snapshot B′ a block pointer P4 pointing to the added data block D4. Then, the file F″ corresponding to the snapshot B′ is displayed on the user interface of the information processing apparatus 100.

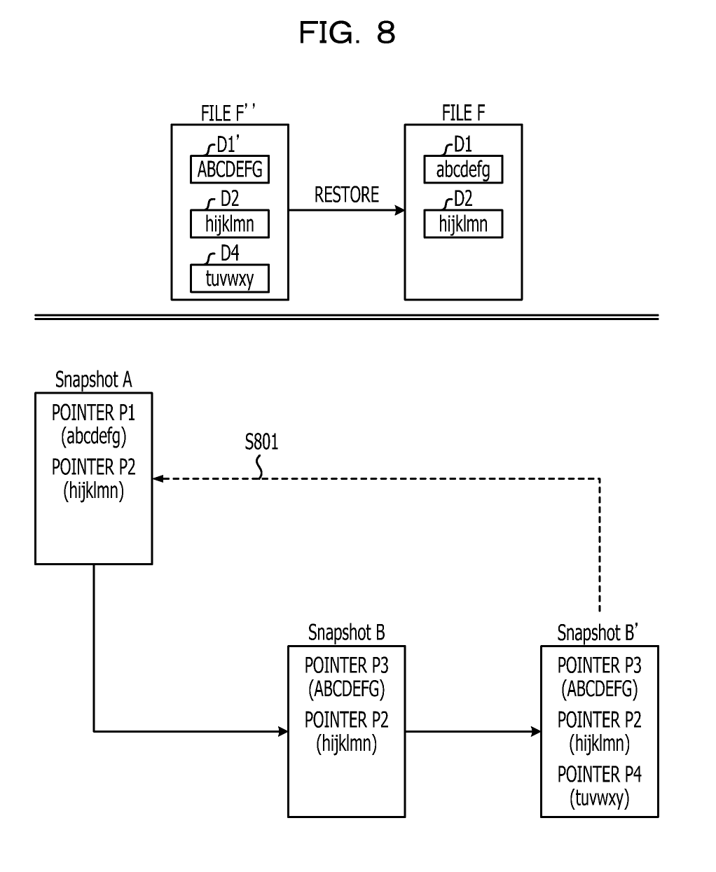

In S801 in FIG. 8, the user of the information processing apparatus 100 restores the file F corresponding to the snapshot A from the file F″ corresponding to the snapshot B′. Specifically, the information processing apparatus 100 changes the data block D group to be displayed on the user interface from the data block D group pointed to by the snapshot B′ to the data block D group pointed to by the snapshot A. Then, the file F is displayed on the user interface of the information processing apparatus 100.

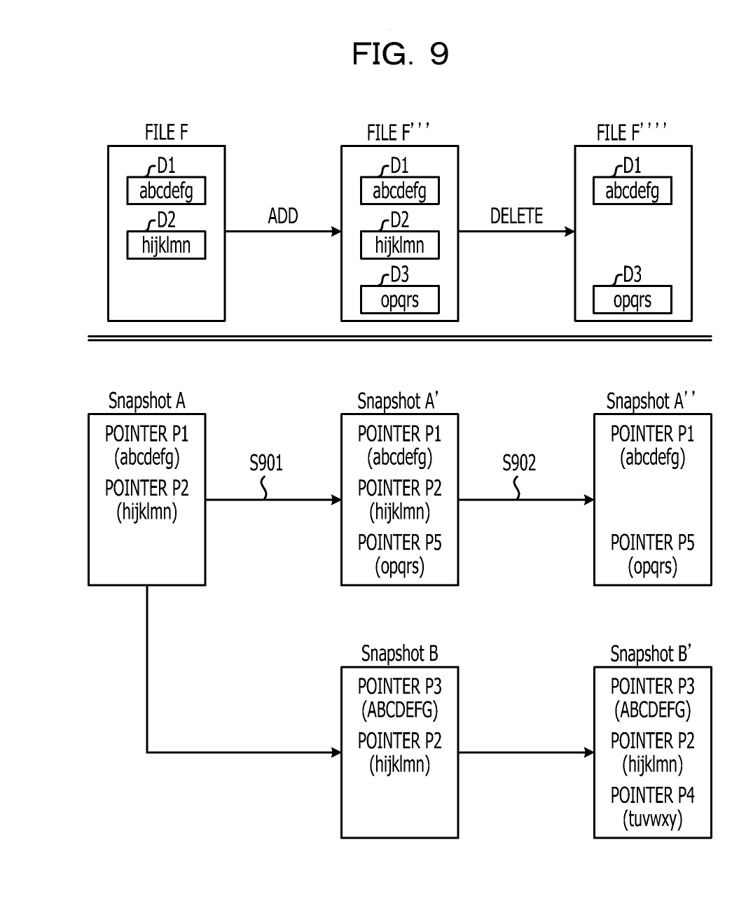

In S901 in FIG. 9, the user of the information processing apparatus 100 copies the snapshot A to obtain a snapshot A′. The user of the information processing apparatus 100 then uses the information processing apparatus 100 to add a data block D3 to the file F corresponding to the snapshot A. The information processing apparatus 100 updates the snapshot A′ to a snapshot A′ for a file F′″ after the addition while leaving the snapshot A for the file F. Specifically, the information processing apparatus 100 adds to the snapshot A′ a block pointer P5 pointing to the added data block D3. Then, the file F′″ is displayed on the user interface of the information processing apparatus 100.

In S902, the user of the information processing apparatus 100 copies the snapshot A′ to obtain a snapshot A″. The user of the information processing apparatus 100 then uses the information processing apparatus 100 to delete the data block D2 from the file F′″ corresponding to the snapshot A′. The information processing apparatus 100 updates the snapshot A″ to a snapshot A″ for a file F″″ after the deletion while leaving the snapshot A′ for the file F′″ before the deletion. Specifically, the information processing apparatus 100 deletes the block pointer P2 pointing to the deleted data block D2 from the snapshot A″. Then, the file F″″ is displayed on the user interface.

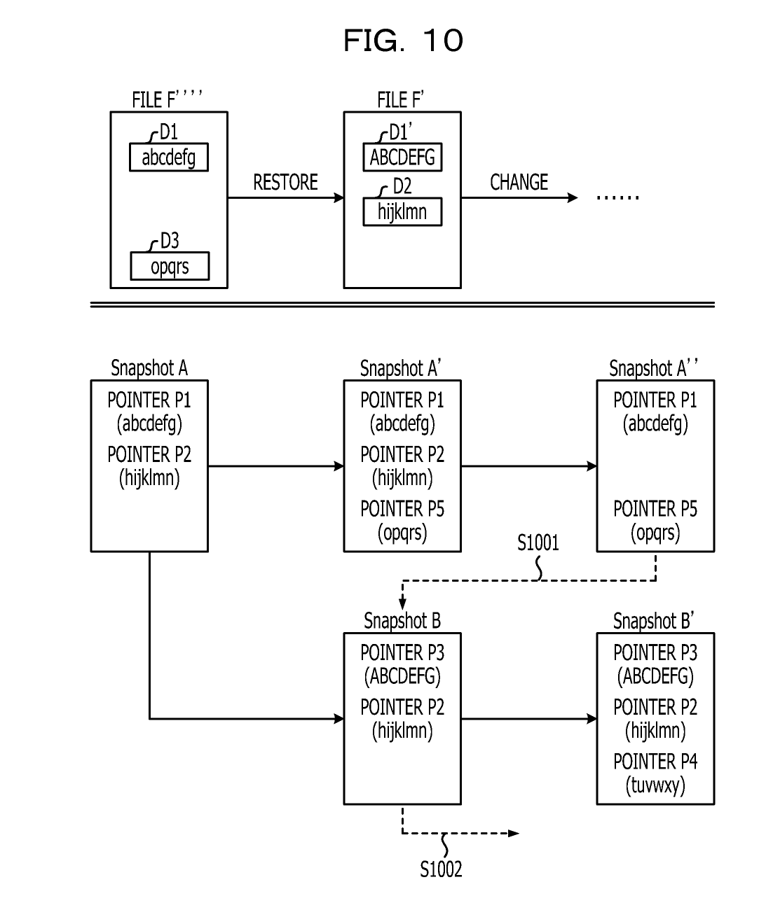

In S1001 in FIG. 10, the user of the information processing apparatus 100 restores the file F′ corresponding to the snapshot B from the file F″″ corresponding to the snapshot A″. Specifically, the information processing apparatus 100 changes data block D group to be displayed on the user interface from the data block D group pointed to by the snapshot A″ to the data block D group pointed to by the snapshot B. Then, the file F′ is displayed on the user interface of the information processing apparatus 100.

In S1002, the user of the information processing apparatus 100 then copies the snapshot B. The user of the information processing apparatus 100 then uses the information processing apparatus 100 to change the file F′ corresponding to the snapshot B. Thus, the information processing apparatus 100 enables another snapshot to branch from the copied snapshot.

As described above, when the user makes a deletion, addition, or change on a file, the information processing apparatus 100 may update the snapshot. The information processing apparatus 100 may automatically copy the snapshot each time the user makes a deletion, addition, or change on a file or may copy the snapshot only when the user requests the copying of the snapshot.

As described above, the information processing apparatus 100 may restore a file to a state at a point in time when a snapshot was created. In the course of restoration, the information processing apparatus 100 does not affect other saved snapshots, so a plurality of snapshots may be present concurrently. The information processing apparatus 100 may also create a snapshot newly branching from a previous snapshot.

### Specific Example of block pointers P used during Creation of Snapshot

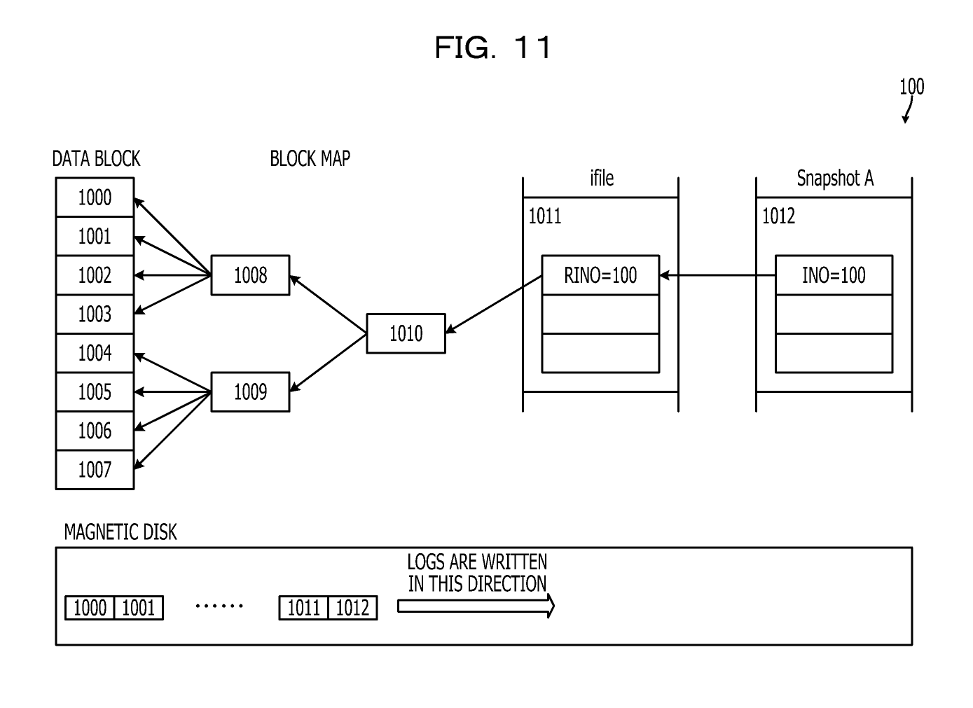

Next, a specific example of block pointers P used during creation of a snapshot will be described with reference to FIGS. 11 to 13.

FIGS. 11 to 13 illustrate a specific example of block pointers P used during creation of a snapshot. Specific examples of block pointers P in a snapshot B will be described below by using a case in which the snapshot B is created from a snapshot A as an example.

As illustrated in FIG. 11, the information processing apparatus 100 stores data blocks D1000 to D1007 included in a file. The information processing apparatus 100 also stores data blocks D1008 to D1010 as a block map to data blocks D1000 to D1007.

The information processing apparatus 100 stores, in a data block D1011 (referred to below as “ifile”), a block pointer P (entry) that points to the data block D at the top of the block map and is used as an identifier of the file. The information processing apparatus 100 also stores, in a data block D1012, a block pointer P that is used in a snapshot. A block pointer P used in a snapshot points to an entry. For example, the pointer P, in a snapshot, with an INO number of 100 points to a block pointer P with an RINO number of 100. On the magnetic disk 204, the data blocks D1000 to D1012 are stored in contiguous spaces.

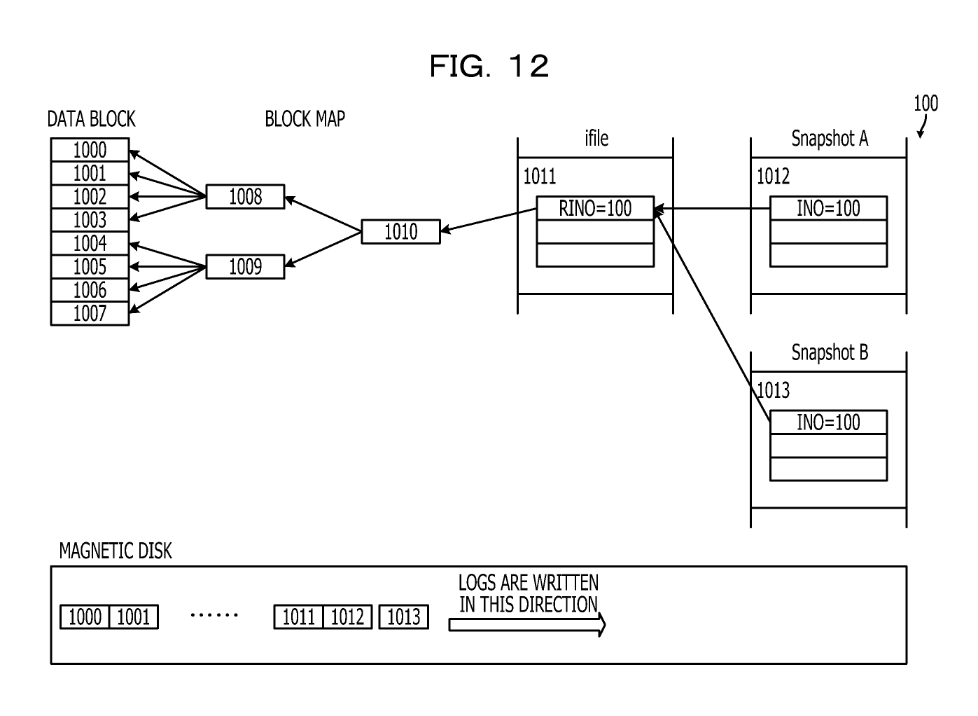

Next, the information processing apparatus 100 copies the snapshot A to create the snapshot B, as illustrated in FIG. 12. A block pointer P that is used in the snapshot B is stored in a data block D1013. In the creation of the snapshot B, the block pointer P in the snapshot A is copied but the data blocks D and the block map are not changed. Accordingly, the information processing apparatus 100 may copy the snapshot at high speed. Since the information processing apparatus 100 uses a log-structured file system, it stores the new data block D1013 in a space contiguous to the data blocks D1000 to D1012 on the magnetic disk 204.

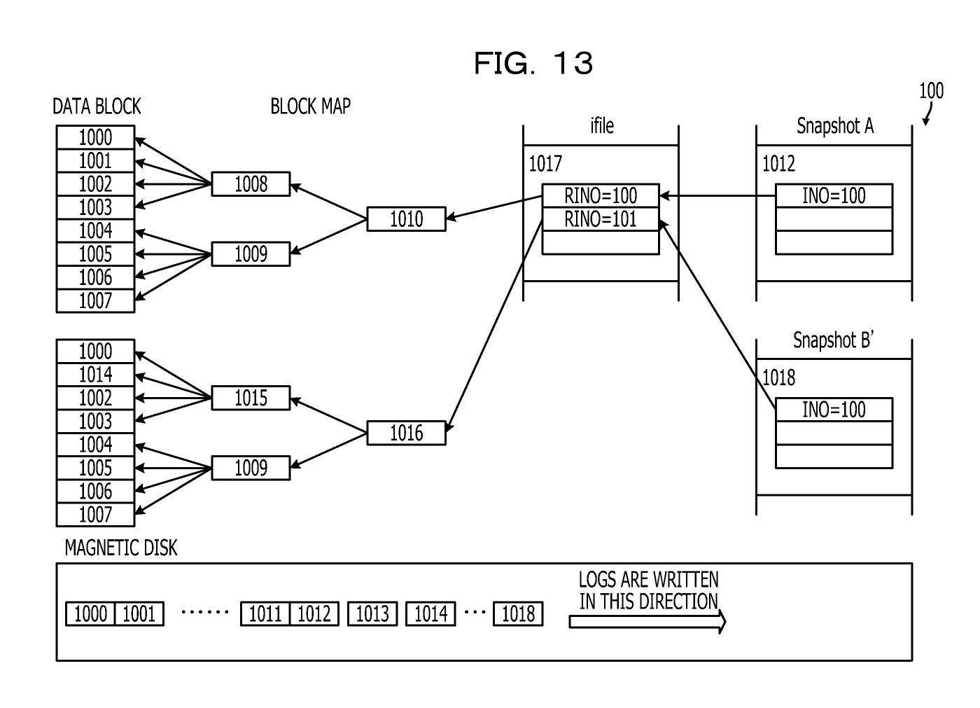

As illustrated in FIG. 13, when the data block D1001 is changed to a data block D1014, the information processing apparatus 100 stores the reflected data block D1014 while leaving the data block D1001 before the change.

Next, the information processing apparatus 100 creates a new block map including data blocks D1015 and D1016 to point to the reflected data block D1014. The information processing apparatus 100 then creates a data block D1017 (new ifile), which includes an entry with an RINO number of 101. The entry is a block pointer P pointing to the data block D1016 at the top of the new block map. The data block D1017 also includes an entry with an RINO number of 100. The entry is included in the data block D1011 (ifile). The information processing apparatus 100 then stores a snapshot B′ in data block D1018, in which the block pointer P in the snapshot B has been changed to a block pointer P pointing to the entry with the new RINO number of 101,.

Since the information processing apparatus 100 uses a log-structured file system, it stores the new data blocks D1014 to D1018 in spaces contiguous to the data blocks D1000 to D1013 on the magnetic disk 204. As a result, on the magnetic disk 204, the data blocks D included in the file, the data blocks D included in the block map, and the data blocks D used as snapshots are stored in physically contiguous spaces.

As described above, when a file is changed, the information processing apparatus 100 may copy the block pointer P group included in a snapshot and may create a new snapshot by changing the data block D group pointed to by the copied block pointer P group included in the snapshot. The information processing apparatus 100 may also identify, on the basis of a snapshot, a file corresponding to the snapshot and may read out data. For example, the information processing apparatus 100 may identify the data block D included in the file corresponding to the snapshot A by tracing pointing destinations from the pointer in the snapshot A and may read out data.

Since the information processing apparatus 100 uses a log-structured file system, the data blocks D included in the file, the data blocks D included in the block map, and the data blocks D used as snapshots are stored in physically contiguous spaces in a storage area. Thus, it becomes possible to reduce the amount of movement of the head to control read/write operations on the magnetic disk 204 when the information processing apparatus 100 executes processing on a file. Accordingly, the performance of the information processing apparatus 100 in reading from and writing to the magnetic disk 204 may be improved.

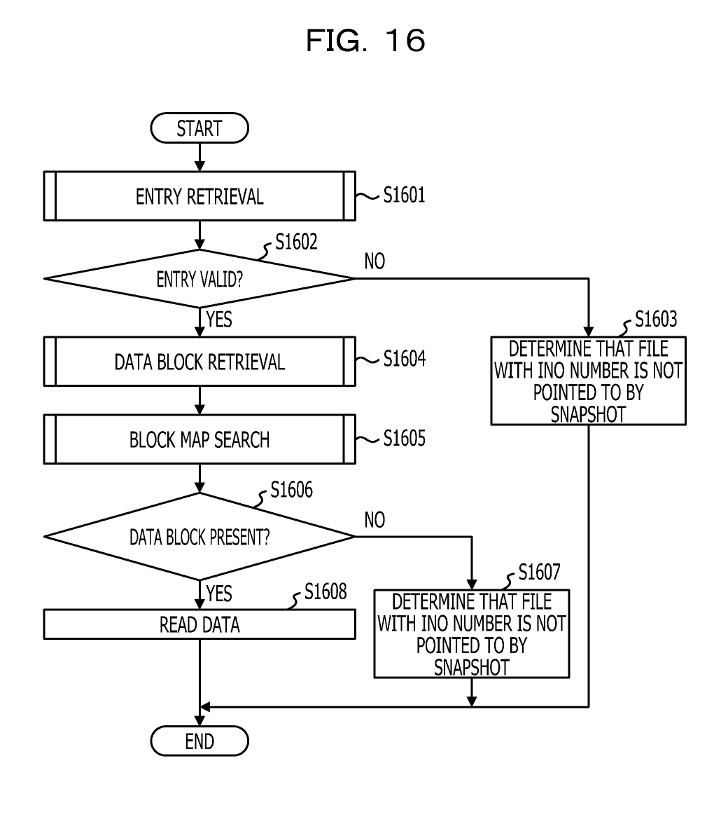

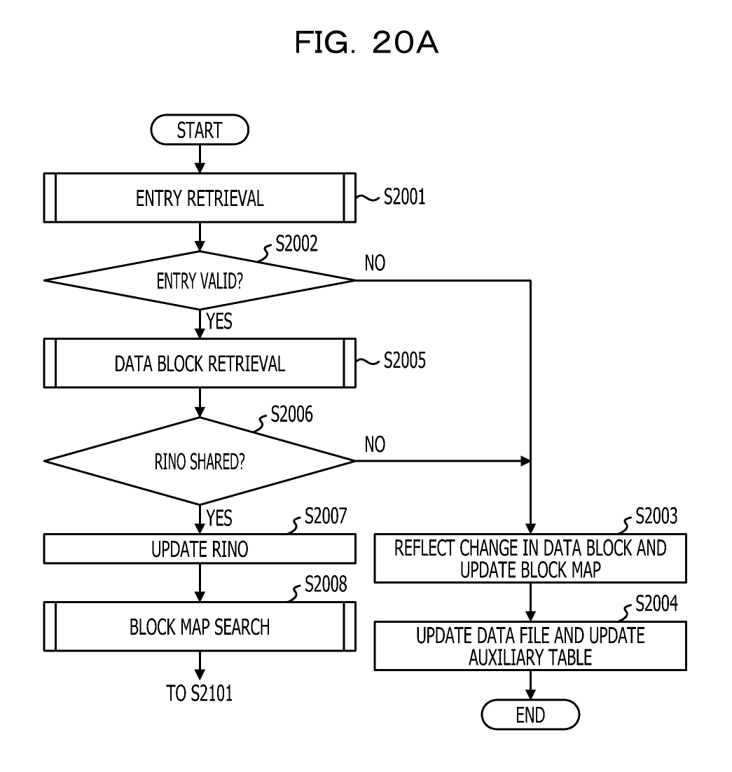

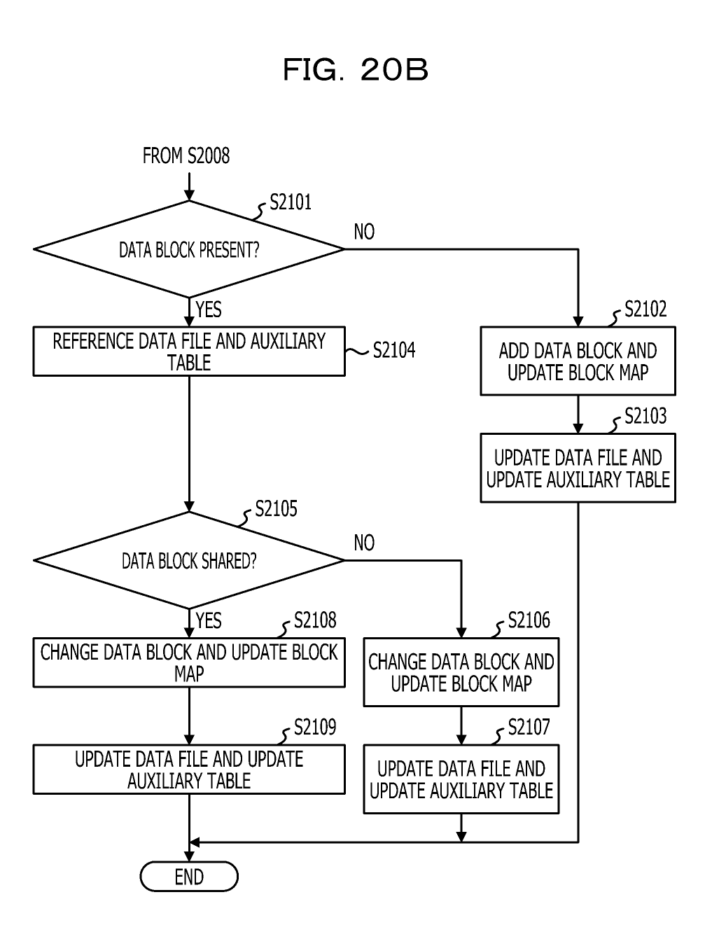

The reading of data will be described later with reference to FIG. 16. How the data blocks D, block map, ifile, and snapshots are updated when the file is changed will be described later with reference to FIGS. 20 and 21.

### Specific Example of Garbage Collection by Information Processing Apparatus 100

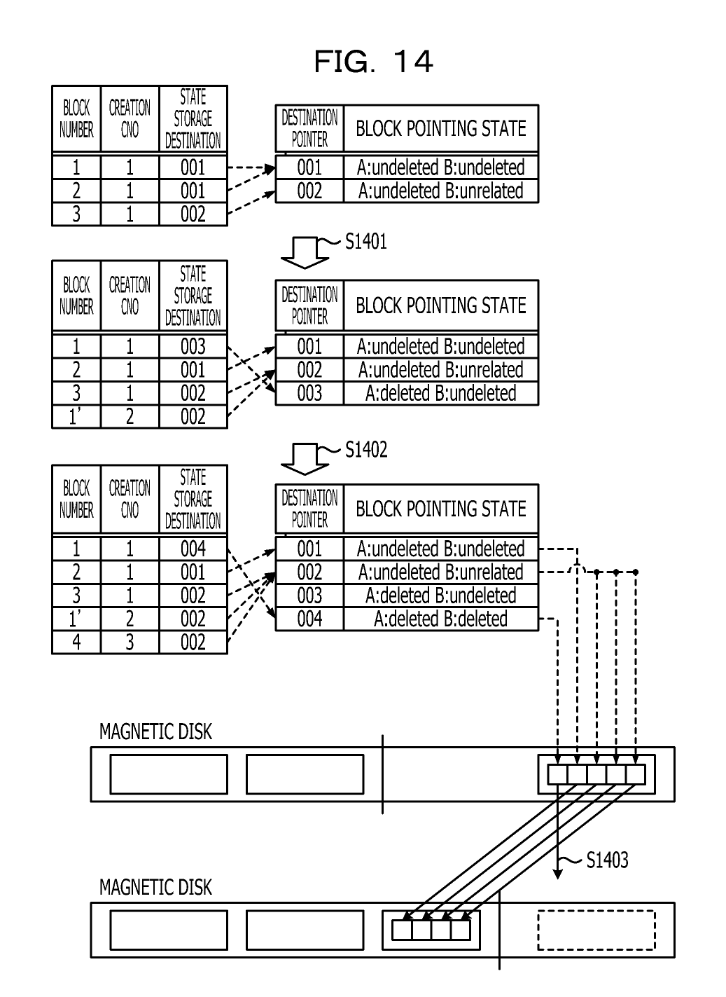

A specific example of garbage collection by the information processing apparatus 100 will be described below with reference to FIG. 14. FIG. 14 illustrates an example in which garbage is collected by using the data file 230 and auxiliary table 500 illustrated in FIG. 5. The data file 230 illustrated in FIG. 3 or 4 may be used for garbage collection.

FIG. 14 illustrates a specific example of garbage collection by the information processing apparatus 100. When the size of the remaining available space in the storage area falls to or below a threshold, the information processing apparatus 100 executes garbage collection to delete unnecessary data blocks D. The information processing apparatus 100 may execute garbage collection at fixed time intervals.

A plurality of snapshots are present concurrently in the information processing apparatus 100. Therefore, even when a data block D is not pointed to by one snapshot, it may be pointed to by another snapshot. In this case, the information processing apparatus 100 does not delete the data block D.

The information processing apparatus 100 may identify a data block D that is not pointed to by any of a plurality of snapshots with reference to the data file 230 (and the auxiliary table 500). The information processing apparatus 100 executes garbage collection by deleting the identified data block D.

An example in which the information processing apparatus 100 stores the data file 230 and auxiliary table 500 for the snapshots A and B corresponding to a file including data blocks D1 to D3 will be described below. For each data block D, a block pointing state in which the data block is pointed to or not by each snapshot is stored in the combination of the data file 230 and auxiliary table 500.

In S1410 in FIG. 14, when the data block D1 is changed to a data block D1′ in the snapshot A, a record regarding the data block D1′ is added to the data file 230 with the record regarding the data block D1 left. Then, a record regarding the block pointing state of the data block D1 is added to the auxiliary table 500. A record regarding the block pointing state of the data block D1′ has been stored in the auxiliary table 500. In the data file 230, a destination pointer “003” of the record added to the auxiliary table 500 is stored as the state storage destination for the data block D1, and a destination pointer “002” of the record in the auxiliary table 500 is stored as the state storage destination for the data block D1′.

In S1402, when a data block D4 is added in the snapshot A, a record regarding the data block D4 is added to the data file 230. A record regarding the block pointing state of the data block D4 has been stored in the auxiliary table 500. In the data file 230, the destination pointer “002” of the record in the auxiliary table 500 is stored as the state storage destination for the data block D4. When the data block D1 is deleted from the snapshot B, a record regarding the new block pointing state of the data block D1 is added to the auxiliary table 500. In the data file 230, a destination pointer “004” of the record added to the auxiliary table 500 is stored as the state storage destination for the data block D1.

Then, in S1403, the information processing apparatus 100 executes garbage collection. The information processing apparatus 100 identifies, with reference to the data file 230 and auxiliary table 500, the data block D1 that is not pointed to by any of the snapshots. The information processing apparatus 100 deletes the identified data block D1 and organizes the remaining available data blocks D in the storage area without deleting them.

Thus, the information processing apparatus 100 may delete unnecessary data blocks D and may release spaces in the storage area. The information processing apparatus 100 may also solve a problem in that a data block D pointed to by a snapshot is deleted unintentionally during execution of garbage collection and the file fails to be restored by using the snapshot.

### Example of User Interface of Snapshots

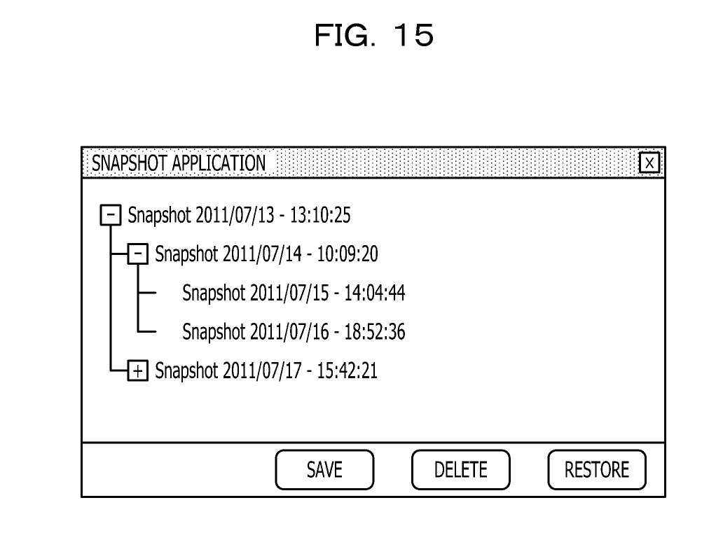

Next, an example of a user interface of snapshots will be described with reference to FIG. 15.

FIG. 15 illustrates an example of a user interface of snapshots. As illustrated in FIG. 15, the information processing apparatus 100 displays a screen of a snapshot management application. In the screen of the snapshot management application, stored snapshots are displayed in a tree structure together with a SAVE button, a DELETE button, and a RESTORE button.

When the SAVE button is clicked, the information processing apparatus 100 saves the current file state as a snapshot. When the DELETE button is clicked, the information processing apparatus 100 deletes a snapshot selected from the displayed snapshots. When the RESTORE button is clicked, the information processing apparatus 100 recovers to the state corresponding to a snapshot selected from the displayed snapshots.

As described above, the user of the information processing apparatus 100 may return to a file state at a point in time when a snapshot was created, according to the snapshot. Even when the file is restored to a previous state, the snapshots may be present concurrently. The user of the information processing apparatus 100 may also store the current file state as a snapshot and may also delete unnecessary snapshots.

### Process of Reading Data from Snapshot

Next, a process of reading data from a snapshot will be described with reference to FIG. 16.

FIG. 16 is a flowchart illustrating a process of data reading. First, the CPU 201 executes a process of entry retrieval (S1601). The CPU 201 then determines whether the entry with an INO number retrieved in the process of entry retrieval is valid (S1602).

When the entry is not valid (the result in S1602 is No), the CPU 201 determines that a file with the INO number is not pointed to by the snapshot (S1603) and terminates the process of data reading.

When the entry is valid (the result in S1602 is Yes), the CPU 201 executes a process of data block retrieval (S1604). Next, the CPU 201 then executes a process of block map search (S1605). The CPU 201 then determines whether there is a data block D according to the result obtained in the process of block map search (S1606).

When there is no data block D (the result in S1606 is No), the CPU 201 determines that a file with the INO number is not pointed to by the snapshot (S1607) and terminates the process of data reading.

When there is a data block D (the result in S1606 is Yes), the CPU 201 reads data in accordance with the operating system (S1608) and terminates the process of data reading.

Thus, the information processing apparatus 100 may identify, on the basis of a snapshot, a file corresponding to the snapshot and may read out data.

### Process of Entry Retrieval

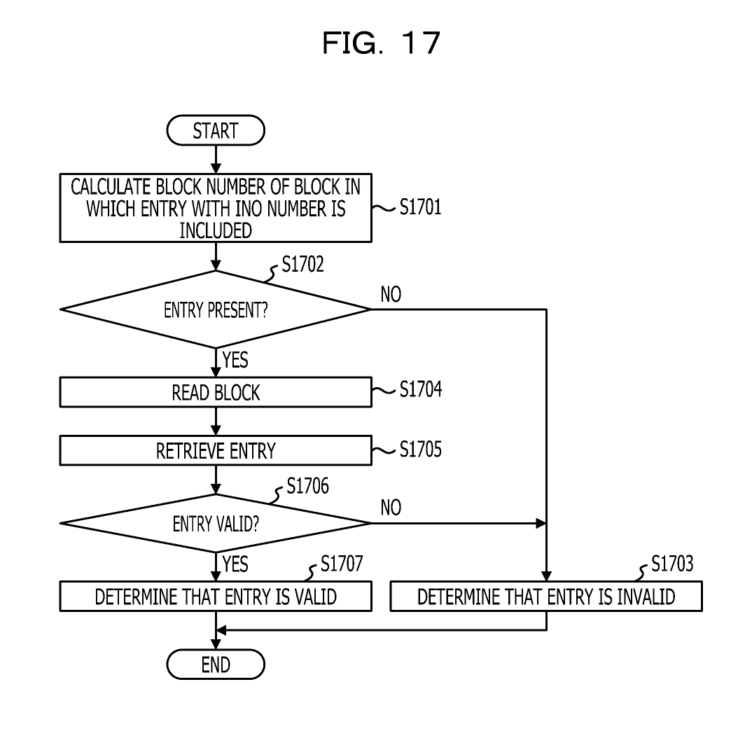

Next, the process of entry retrieval executed in S1601 in FIG. 16 will be described with reference to FIG. 17.

FIG. 17 is a flowchart illustrating a process of entry retrieval. First, the CPU 201 calculates the block number of a block that includes an entry with an INO number (S1701). The CPU 201 then determines whether there is an entry in the snapshot (S1702). When there is no entry (the result in S1702 is No), the CPU 201 determines that the entry is invalid (S1703) and terminates the process of entry retrieval.

When there is an entry (the result in S1702 is Yes), the CPU 201 reads a block with a block number x in accordance with the operating system (S1704) and retrieves the entry (S1705). The CPU 201 then determines whether the entry is valid (S1706). When the entry is not valid (the result in S1706 is No), the CPU 201 determines that the entry is invalid (S1703) and terminates the process of entry retrieval.

When the entry is valid (the result in S1706 is Yes), the CPU 201 determines that the entry is valid (S1707) and terminates the process of entry retrieval.

### Process of Data Block Retrieval

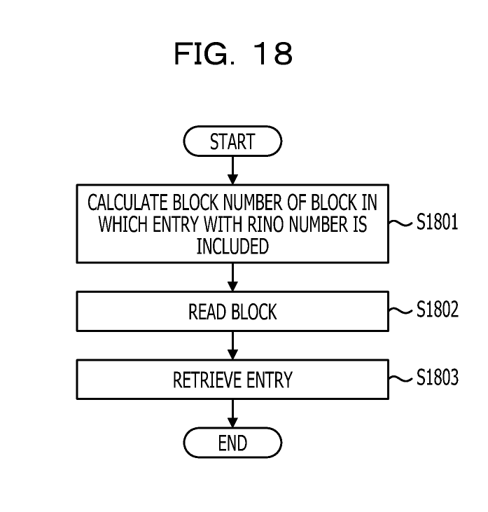

Next, a process of data block retrieval executed in S1604 in FIG. 16 will be described with reference to FIG. 18.

FIG. 18 is a flowchart illustrating a process of data block retrieval. First, the CPU 201 calculates the block number x of a block in an ifile, which includes an entry with an RINO number (S1801). The CPU 201 then reads a data block D with the block number x in accordance with the operating system (S1802) and retrieves the entry with the RINO number (S1803). The CPU 201 then terminates the process of data block retrieval.

### Process of Block Map Search

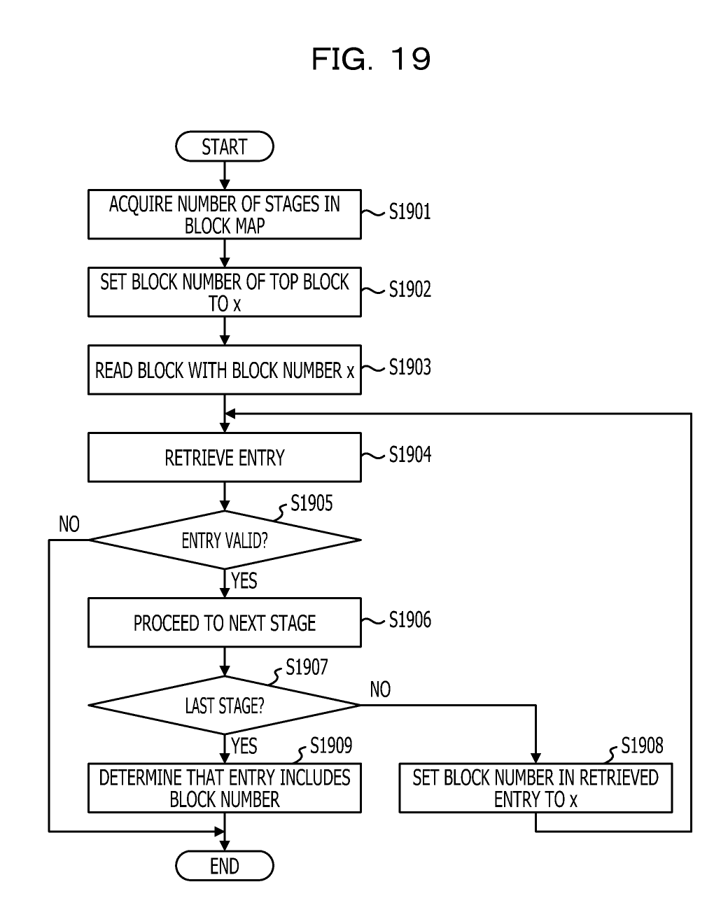

Next, a process of block map search executed in S1605 in FIG. 16 will be described with reference to FIG. 19.

FIG. 19 is a flowchart illustrating a process of block map search. First, the CPU 201 acquires the number of stages in the block map from RINO number meta information (S1901). The CPU 201 then acquires the block number of the top block from the RINO number meta information and sets the acquired block number to x (S1902). The CPU 201 then reads a block with a block number x in accordance with the operating system (S1903).

Next, the CPU 201 retrieves an entry with a specified offset (S1904). The CPU 201 then determines whether the retrieved entry is valid (S1905). When the entry is not valid (the result in S1905 is No), the CPU 201 terminates the process of block map search.

When the entry is valid (the result in S1905 is Yes), the CPU 201 proceeds to the next stage (S1906) and determines whether the stage is the last stage (S1907). When the stage is not the last stage (the result in S1907 is No), the CPU 201 sets the block number in the retrieved entry to x (S1908), and returns to S1904.

When the stage is the last stage (the result in S1907 is Yes), the CPU 201 determines that the retrieved entry includes a block number (S1909) and terminates the process of block map search.

### Process of Data Writing

A process of data writing will be described below with reference to FIGS. 20A and 20B.

FIGS. 20A and 20B illustrate a flowchart of a process of data writing. In FIG. 20A, the CPU 201 first executes the process of entry retrieval for the INO number specified in a snapshot (S2001). The CPU 201 then determines whether the retrieved entry is valid (S2002).

When the entry is not valid (the result in S2002 is No), the CPU 201 changes the data block D and updates the block map (S2003). The CPU 201 then updates a record regarding the reflected data block D in the data file 230 and then updates the auxiliary table 500.

Specifically, when the auxiliary table 500 includes a record regarding a block pointing state in which the reflected data block D is pointed to or not by each snapshot, the CPU 201 changes the destination pointer for the reflected data block D in the data file 230 to the destination pointer of the record in the auxiliary table 500. When the auxiliary table 500 does not include a record regarding the block pointing state in which the reflected data block D is pointed to or not by each snapshot, the CPU 201 adds a record regarding the block pointing state to the auxiliary table 500. The CPU 201 then updates the destination pointer for the reflected data block D in the data file 230 to the destination pointer of the record added to the auxiliary table 500 (S2004). The CPU 201 then terminates the process of data writing.

When the entry is valid (the result in S2002 is Yes), the CPU 201 executes the process of data block retrieval (S2005). Next, the CPU 201 determines whether the RINO number of the retrieved data block D is shared with another snapshot (S2006). When the retrieved data block D is not shared (the result in S2006 is No), the CPU 201 proceeds to S2003.

When the retrieved data block D is shared (the result in S2006 is Yes), the CPU 201 updates the RINO number (S2007). The CPU 201 then executes the process of block map search (S2008) and proceeds to S2101 in FIG. 20B.

In FIG. 20B, the CPU 201 determines whether there is a data block D (S2101). When there is no data block D (the result in S2101 is No), the CPU 201 adds a data block D and updates the block map (S2102). The CPU 201 then adds a record regarding the added data block D to the data file 230 and then updates the auxiliary table 500.

Specifically, when the auxiliary table 500 includes a record regarding a block pointing state in which the added data block D is pointed to or not by each snapshot, the CPU 201 adds, to the data file 230, a record storing information indicating the added data block D in correspondence to a destination pointer of the record in the auxiliary table 500. When the auxiliary table 500 does not include a record regarding the block pointing state in which the added data block D is pointed to or not by each snapshot, the CPU 201 adds a record regarding the block pointing state to the auxiliary table 500. The CPU 201 then adds, to the data file 230, a record storing information indicating the added data block D in correspondence to a destination pointer of the record added to the auxiliary table 500 (S2103) and terminates the process of data writing.

When there is a data block D (the result in S2101 is Yes), the CPU 201 references the data file 230 and auxiliary table 500 (S2104) and determines whether the data block D is shared with another snapshot (S2105).

When the data block D is not shared (the result in S2105 is No), the CPU 201 changes the to-be-reflected data block D to a reflected data block D and updates the block map (S2106). The CPU 201 then updates the record regarding the reflected data block D in the data file 230 and then updates the auxiliary table 500.

Specifically, when the auxiliary table 500 includes a record regarding a block pointing state in which the reflected data block D is pointed to or not by each snapshot, the CPU 201 changes the destination pointer for the reflected data block D to the destination pointer of the record in the auxiliary table 500. When the auxiliary table 500 does not include a record regarding the block pointing state in which the reflected data block D is pointed to or not by each snapshot, the CPU 201 adds a record regarding the block pointing state to the auxiliary table 500. The CPU 201 then updates the destination pointer of the reflected data block D in the data file 230 to the destination pointer of the record added to the auxiliary table 500 (S2107) and then terminates the process of data writing.

When the data block D is shared (the result in S2105 is Yes), the CPU 201 creates a reflected data block D while leaving the to-be-reflected data block D before the change, and updates the block map (S2108). Next, the CPU 201 adds, to the data file 230, a record regarding the reflected data block D, updates the record regarding the to-be-reflected data block D in the data file 230, and then updates the auxiliary table 500.

Specifically, when the auxiliary table 500 includes a record regarding a block pointing state in which the reflected data block D is pointed to or not by each snapshot, the CPU 201 changes the destination pointer for the reflected data block D in the data file 230 to the destination pointer of the record in the auxiliary table 500. When the auxiliary table 500 does not include a record regarding a block pointing state in which the reflected data block D is pointed to or not by each snapshot, the CPU 201 adds a record regarding the block pointing state to the auxiliary table 500. The CPU 201 then updates the destination pointer for the reflected data block D in the data file 230 to the destination pointer of the record added to the auxiliary table 500 (S2109) and then terminates the process of data writing.

Thus, when a file is changed, the information processing apparatus 100 may store the data block D corresponding to the file after the change, create a new block map and a new entry, and update the data file 230 and auxiliary table 500. When data is deleted from a file, the information processing apparatus 100 may create a new block map and a new entry and update the data file 230 and auxiliary table 500. When data is added to a file, the information processing apparatus 100 may store a data block D to be added to the file, create a new block map and a new entry, and update the data file 230 and auxiliary table 500.

As described above, when a file is changed, the information processing apparatus 100 stores the data block D after the change, which is created by reflecting the change in the data block D corresponding to the to-be-changed portion in the file, while leaving the data block D corresponding to the to-be-changed portion. The information processing apparatus 100 also stores a snapshot that includes a block pointer P group pointing to the data block D group included in the file after the change while leaving the snapshot including the block pointer P group pointing to the data block D group included in the file before the change.

When data is added to a file, the information processing apparatus 100 stores the data block D corresponding to the added portion in the file. The information processing apparatus 100 also stores a snapshot that includes a block pointer P group pointing to the data block D group included in the file after the addition while leaving the snapshot including the block pointer P group pointing to the data block D group included in the file before the addition.

When data is deleted from a file, the information processing apparatus 100 stores the data block D corresponding to the to-be-deleted portion in the file. The information processing apparatus 100 also stores a snapshot that includes a block pointer P group pointing to the data block D group included in the file after the deletion while leaving the snapshot including the block pointer P group pointing to the data block D group included in the file before the deletion.

Accordingly, a plurality of snapshots may be present concurrently in the information processing apparatus 100. As a result, the information processing apparatus 100 may switch a file to the state corresponding to any snapshot. The information processing apparatus 100 may also create a snapshot newly branching from any snapshot in time-series snapshots while retaining the time-series snapshots.

Each snapshot is independent and is not affected even when another snapshot is operated. Accordingly, even when the information processing apparatus 100 restores a file to a state corresponding to one of the snapshots, the information processing apparatus 100 may return to the state corresponding to the snapshot before the restoration. The information processing apparatus 100 may selectively use a file among the states corresponding to a plurality of branched parallel snapshots.

The information processing apparatus 100 stores information about whether each data block D is pointed to by any snapshot. During garbage collection, the information processing apparatus 100 deletes a data block D that is not pointed to by any snapshot. Therefore, even when the information processing apparatus 100 executes garbage collection, the snapshots do not have a problem.

Since the information processing apparatus 100 uses a log-structured file system, when a file is written to, the information processing apparatus 100 writes, as a log, a changed portion to a contiguous space on a disk which is used as a storage area. Therefore, the amount of movement of the head with respect to the magnetic disk 204 is reduced even in random writing when compared with a file system without a log structure, enabling performance close to sequential writing to be obtained in random writing.

The information processing method described in this embodiment may be implemented by having a personal computer, a workstation, or another type of computer execute a program prepared in advance. The information processing program in this embodiment is recorded on a hard disk, a flexible disk, a compact disc-read-only memory (CD-ROM), a magneto-optic (MO) disk, a digital versatile disk (DVD), or another type of computer-readable recording medium. The information processing program is executed when it is read from the recording medium by the computer. The information processing program may be distributed through the Internet or another network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a processor to
store first pointer group information in a memory when first data is stored in a storage unit, the first pointer group information including block pointers respectively pointing to primary data blocks of the storage unit, the primary data blocks storing the first data, each of the primary data blocks storing a divided part of the first data, and
store second pointer group information in the memory when data update for updating the first data to second data is performed, the second pointer group information including block pointers respectively pointing to secondary data blocks of the storage unit, the secondary data blocks storing the second data, each of the secondary data blocks storing a divided part of the second data,
wherein
the second pointer group information does not include a first block pointer included in the first pointer group information when a to-be-deleted portion of the first data is deleted by the data update, the first block pointer pointing to a first data block storing the to-be-deleted portion,
the second pointer group information includes a second block pointer when an added portion is added by the data update, the second block pointer pointing to a second data block storing the added portion, and
the second pointer group information includes a third block pointer included in the first pointer group information when an unchanged portion of the first data remains by the data update, the third block pointer pointing to a third data block storing the unchanged portion.

2. The information processing apparatus according to claim 1, further comprising:
a first database to store a destination pointer for each source data block included in a set of data blocks; and
a second database to store state information regarding a state of a source data block for each destination pointer,
wherein
the processor
updates, when the to-be-deleted portion of the first data is deleted by the data update, a first destination pointer for the first data block to a second destination pointer, and
adds first state information to the second database in correspondence to the second destination pointer, the first state information indicating a state in which the first data block is pointed to by a block pointer included in the first pointer group information and is not pointed to by any block pointer included in the second pointer group information,
wherein
the processor
adds, when the added portion is added by the data update, a third destination pointer to the first database in correspondence to information indicating the second data block, and
adds second state information to the second database in correspondence to the third destination pointer, the second state information indicating a state in which the first data block is not pointed to by any block pointer included in the first pointer group information and is pointed to by a block pointer included in the second pointer group information.

3. The information processing apparatus according to claim 1, further comprising:
a first database to store a destination pointer for each source data block included in a set of data blocks; and
a second database to store state information regarding a state of a source data block for each destination pointer,
wherein
the processor updates, when the to-be-deleted portion of the first data is deleted by the data update, a first destination pointer for the first data block to a second destination pointer, the second destination pointer being stored in the second database in correspondence to first state information indicating a state in which the first data block is pointed to by a block pointer included in the first pointer group information and is not pointed to by any block pointer included in the second pointer group information,
wherein
the processor adds, when the added portion is added by the data update, a third destination pointer to the first database in correspondence to information indicating the second data block, the third destination pointer being stored in the second database in correspondence to second state information indicating a state in which the first data block is not pointed to by any block pointer included in the first pointer group information and is pointed to by a block pointer included in the second pointer group information.

4. The information processing apparatus according to claim 2, wherein the processor refers to the first database and the second database to delete, from the set of data blocks, a data block that is not pointed to by any block pointer included in any pointer group information.

5. The information processing apparatus according to claim 3, wherein the processor refers to the first database and the second database to delete, from the set of data blocks, a data block that is not pointed to by any block pointer included in any pointer group information.

6. An information processing method executed by a computer, the information processing method comprising:
storing, by the computer, first pointer group information in a memory when first data is stored in a storage unit, the first pointer group information including block pointers respectively pointing to primary data blocks of the storage unit, the primary data blocks storing the first data, each of the primary data blocks storing a divided part of the first data; and
storing second pointer group information in the memory when data update for updating the first data to second data is performed, the second pointer group information including block pointers respectively pointing to secondary data blocks of the storage unit, the secondary data blocks storing the second data, each of the secondary data blocks storing a divided part of the second data,
wherein
the second pointer group information does not include a first block pointer included in the first pointer group information when a to-be-deleted portion of the first data is deleted by the data update, the first block pointer pointing to a first data block storing the to-be-deleted portion,
the second pointer group information includes a second block pointer when an added portion is added by the data update, the second block pointer pointing to a second data block storing the added portion, and
the second pointer group information includes a third block pointer included in the first pointer group information when an unchanged portion of the first data remains by the data update, the third block pointer pointing to a third data block storing the unchanged portion.

7. A computer-readable recording medium storing a program that causes a computer to execute a procedure, the procedure comprising:
storing first pointer group information in a memory when first data is stored in a storage unit, the first pointer group information including block pointers respectively pointing to primary data blocks of the storage unit, the primary data blocks storing the first data, each of the primary data blocks storing a divided part of the first data; and
storing second pointer group information in the memory when data update for updating the first data to second data is performed, the second pointer group information including block pointers respectively pointing to secondary data blocks of the storage unit, the secondary data blocks storing the second data, each of the secondary data blocks storing a divided part of the second data,
wherein
the second pointer group information does not include a first block pointer included in the first pointer group information when a to-be-deleted portion of the first data is deleted by the data update, the first block pointer pointing to a first data block storing the to-be-deleted portion,
the second pointer group information includes a second block pointer when an added portion is added by the data update, the second block pointer pointing to a second data block storing the added portion, and
the second pointer group information includes a third block pointer included in the first pointer group information when an unchanged portion of the first data remains by the data update, the third block pointer pointing to a third data block storing the unchanged portion.
